(19) United States
(12) Patent Application Publication
(10) Pub. No.: US 2011/0238625 A1
(43) Pub. Date: Sep. 29, 2011

(54) INFORMATION PROCESSING SYSTEM AND METHOD OF ACQUIRING BACKUP IN AN INFORMATION PROCESSING SYSTEM

(75) Inventors: Masaki Hamaguchi, Odawara (JP); Akitatsu Harada, Odawara (JP); Kyosuke Achiwa, Yokohama (JP)

(73) Assignee: Hitachi, Ltd., Chiyoda-ku, Tokyo (JP)

(21) Appl. No.: 12/307,992

(22) PCT Filed: Dec. 22, 2008
(86) PCT No.: PCT/JP2008/072458

§ 371 Date: Jan. 8, 2009

(51) Int. Cl. G06F 17/30

(52) U.S. Cl. 707/640; 707/E17.007

(57) ABSTRACT

Provided is an information processing system including a plurality of nodes 3 and a plurality of storages 4 coupled subordinately to each of the nodes 3, each of the nodes 3 functioning as a virtual file system that provides a client 2 with storage regions of each of the storages 4 as a single namespace. This information processing system is further provided with a backup node 10 and a backup storage 11 coupled subordinately to the backup node 10. The backup node 10 synchronizes and holds location information (file management table 33) held by each of the nodes 3. Then, the backup node 10 creates a backup file, and stores the backup file in the backup storage 11 by accessing a location identified by the location information (file management table 43) synchronized and held by the backup node 10 itself to acquire a file.

### TECHNICAL FIELD

The present invention relates to an information processing system and a method of acquiring a backup in an information processing system, and particularly to a technique for an information processing system, which is constituted of a plurality of nodes having a plurality of storages and includes a virtual file system providing the client with storage regions of the storages as a single namespace, to efficiently acquire a backup while suppressing influence on a service to a client.

### BACKGROUND ART

For example, Japanese Patent Application Laid-open Publication No. 2007-200089 discloses a technique for solving a problem that, in a system having a virtual file system constructed with a global namespace, a backup instruction needs to be given to each of all file sharing servers at the time of backing up the virtual file system. Specifically, in this technique, when any one of the file servers receives a backup request from a backup server, the file server which has received the backup request searches out a file server managing a file to be backed up and transfers the backup request to the searched-out file server.

Japanese Patent Application Laid-open Publication No. 2007-272874 discloses that a first file server receives a backup request, copies data managed by the first file server to a backup storage apparatus, and transmits a request to a second file server of file servers to copy data managed by the second file server to the backup storage apparatus.

In both methods described above, a file server itself directly performing a service for a client receives a backup request, identifies a file server managing a file to be backed up, and performs a backup process to a backup storage. Therefore, a process load for the backup influences the service for the client.

The present invention has been made in view of such a background, and aims to provide an information processing system and an information processing method. The information processing system is constituted of a plurality of nodes having a plurality of storages, includes a virtual file system which provides the client with a storage region of a storage as a single namespace, and is capable of efficiently acquiring a backup while suppressing influence on a service to a client.

### DISCLOSURE OF THE INVENTION

In order to achieve the object described above, one aspect of the present invention provides an information processing system comprising a plurality of nodes coupled with a client, a plurality of storages coupled subordinately to the respective nodes, a backup node coupled with each of nodes, and a backup storage coupled subordinately to the backup node, wherein each of the nodes synchronizes and holds location information as information showing a location of a file stored in each of the storages, each of the nodes function as a virtual file system that provides to the client a storage region of each of the storages as a single namespace, and the backup node stores, as a replica of the file, a backup file in the backup storage by synchronizing and holding the location information held by each of the nodes, and acquiring the file by accessing the location identified by the location information synchronized and held by the backup node itself.

In the information processing system, the backup node is provided as a node different from the node which receives an input/output request from the client, the backup node holds the location information managed to synchronize with the location information (file management table) held by each node, and the backup node accesses the storage on the basis of the location information synchronized and held by itself to acquire the original file and store the backup file. Therefore, the backup file can be created efficiently while suppressing influence of each node on the service for the client.

Since the backup files are collectively managed in the backup storage, the backup node can easily perform management of backup such as on the presence or absence of backup of each file. By installing in a remote site the backup storage which collectively manages the backup files in this manner, a disaster recovery system can be easily constructed.

Another aspect of the present invention provides the information processing system, in which a backup flag showing whether or not a backup is necessary for each of the files is held in addition to the files stored in the respective storages, and in which the backup node accesses the location identified by the location information to acquire the backup flag of the file, and stores in the backup storage only the backup file of the file of which the backup flag is set as backup necessary.

Since the backup is created mainly involving the backup node in this manner in the information processing system of the present invention, a user only needs to set the backup flag for each file in advance (without necessarily transmitting a backup request every time) to easily and reliably acquire the backup file.

Another aspect of the present invention provides the information processing system, in which an original file is stored in one of the storages, a replica file as a replica of the original file is stored in the storage different from the storage storing the original file, and the backup node stores in the backup storage a backup file of each of the original file or the replica file.

In an information processing system handling an archive file (original file), one or more replica files may be managed for the original file. However, in the information processing system of the present invention, the original file and the replica file are not distinguished and the backup files can be created by the same processing method (algorithm), even in the case where the original file and the replica file thereof are managed in this manner.

Another aspect of the present invention provides the information processing system, in which a backup apparatus is coupled to the backup storage via a storage network, and in which the backup storage transfers the backup file stored in the backup storage to the backup apparatus via the storage network.

In the information processing system of the present invention, the backup files are collectively managed in the backup storage. Therefore, data transfer of the backup file stored in the backup storage can be performed at high speed in block units by coupling the backup apparatus to the backup storage via the storage network. Since the backup is performed via the storage network, influence on the client can be suppressed.

Another aspect of the present invention provides the information processing system, in which the backup node identifies a location of a file stored in each of the nodes on the basis of the synchronized location information held by the backup node, and transfers the backup file stored in the backup storage to the identified location.

In the information processing system of the present invention, the backup files are collectively managed in the backup storage. The backup node itself also synchronizes and holds location information (file management table). Therefore, in the case where the file of the storage of each node is damaged due to failure or the like, the file of the backup node can be restored easily and promptly in each restored storage on the basis of the location information synchronized and held by the backup node.

In other words, a typical recovery process (restoring) in a conventional information processing system, which includes a virtual file system providing the client with a storage regions of the storages as a single namespace is performed by rewriting on the client side (or an external backup server of an information processing system). In this case, decrease in performance is inevitable since search process requires to be performed for determining the location (storing location) where the data to be recovered originally existed. However, in the present invention, such a decrease in performance does not occur.

Other problems and solutions thereof disclosed in this application shall become clear from the description of the embodiments and drawings of the invention.

According to the present invention, a backup can be acquired efficiently while suppressing influence on the service to a client.

### BRIEF DESCRIPTION OF THE DRAWINGS

FIG. 1A is a view showing a schematic configuration of an information processing system 1.

FIG. 1B is a view showing one example of a hardware configuration of a computer 50 which can be used as a client 2, first to n-th nodes 3, and a backup node 10.

FIG. 1C is a view showing one example of a hardware configuration of storage 60.

FIG. 2 is a view illustrating a method of storing files to first to n-th storages 4.

FIG. 3 is a view showing functions of the first to n-th nodes 3 and a table held by each node 3.

FIG. 4 is a view showing functions of the backup node 10 and a table held by the backup node 10.

FIG. 5 is a view showing a configuration of a file management table 33.

FIG. 6 is a view showing one example of a backup management table 44 held by the backup node 10.

FIG. 7 is a view showing a configuration of file management information 700.

FIG. 8A is a flowchart illustrating a file storage process S800.

FIG. 8B is a flowchart illustrating a storage destination determination process S812.

FIG. 9 is a flowchart illustrating a file access process S900.

FIG. 10 is a flowchart illustrating a backup file storage processing unit 41.

FIG. 11 is a flowchart illustrating a restore process S1100.

### MODE FOR CARRYING OUT THE INVENTION

Hereinafter, an embodiment of the present invention will be described with reference to the drawings.

### =System Configuration=

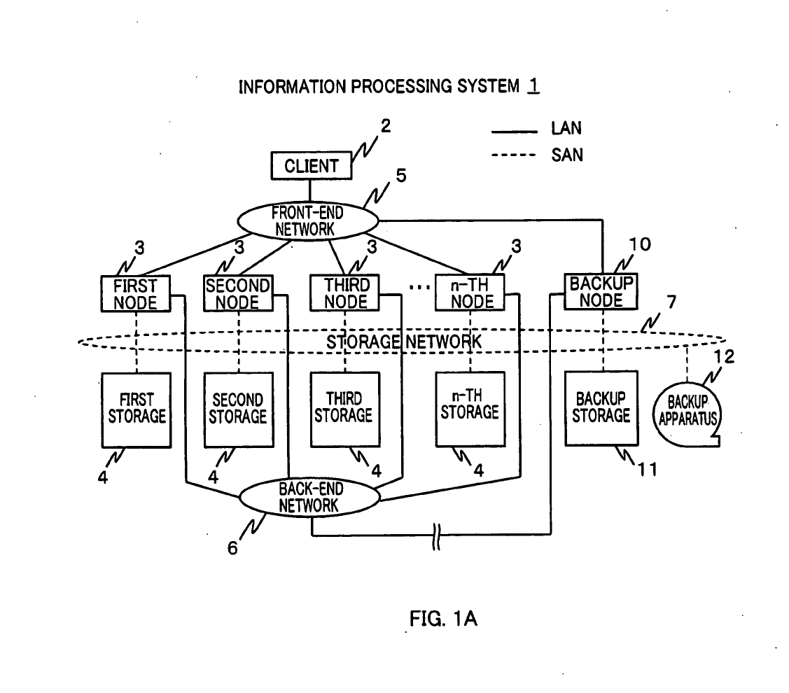

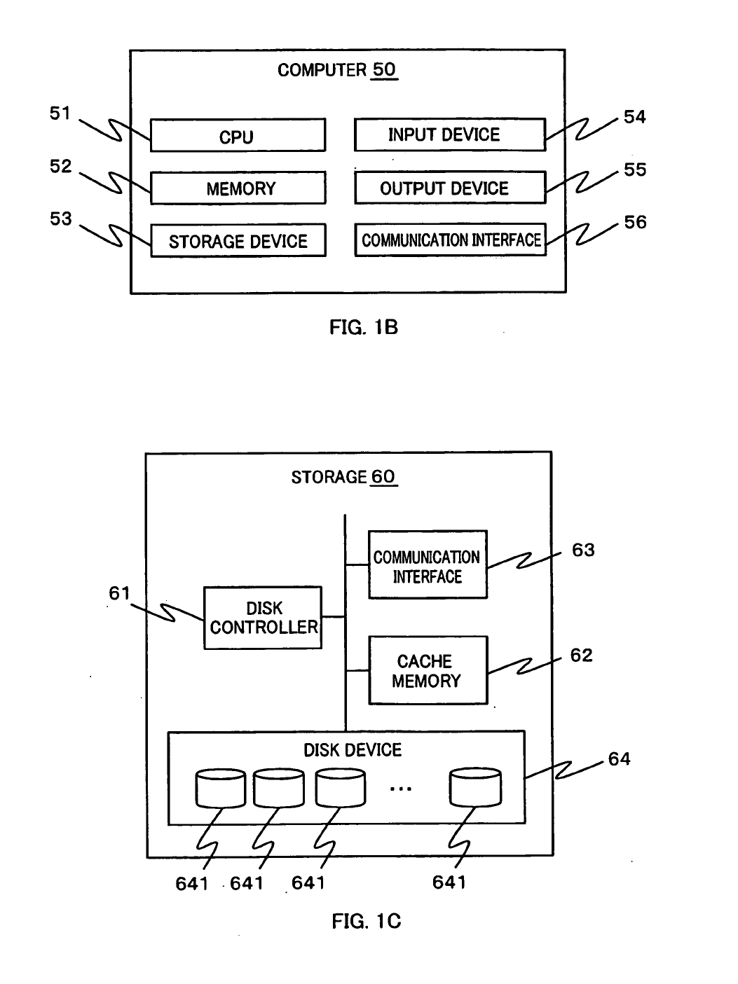

FIG. 1A shows a configuration of an information processing system 1 illustrated in the present embodiment. As shown in FIG. 1A, the information processing system 1 includes a client 2, first to n-th nodes 3 (n=1, 2, 3, . . . ), first to n-th storages 4 coupled subordinately to the respective first to n-th nodes 3, a backup node 10, a backup storage 11 coupled subordinately to the backup node 10, and a backup apparatus 12.

The first to n-th nodes 3 function as a virtual file system in which storage regions of the first to n-th storages 4 coupled subordinately to the respective first to n-th nodes 3 are provided as a single namespace to the client 2. The virtual file system multiplexes and manages a file received from the client 2. That is, the first to n-th storages store an original file received from the client 2 and one or more replica files of the original file. For the purpose of improving fault tolerance, distributing loads, and the like, the replica file is stored in a node 3 different from the node 3 storing the original file.

The client 2 transmits a file storage request (new file creation request) designating a file ID (file name) and a file access request (file read, update, or deletion request) to one node 3 of the first to n-th nodes 3. When any of the nodes 3 receives the file storage request, one node 3 of the first to n-th nodes 3 stores the original file (archive file). A node 3 different from the node 3 storing the original file stores a replica file of the original file.

When any of the nodes 3 receives a file access request, that node 3 refers to a file management table 33 (location information) held by itself to identify the node 3 storing a subject file for the file access request, and acquires data of the subject file for the access request from the node 3 or transmits an update or deletion request of the file to the node 3. The node 3 which has received the file access request makes a reply (read data or update or deletion completion notification) to the client 2.

A front-end network 5 and a back-end network 6 shown in FIG. 1A are, for example, a LAN (Local Area Network), a WAN (Wide Area Network), the Internet, a dedicated line, or the like. The client 2, the first to n-th nodes 3, and the backup node 10 are coupled with each other via the front-end network 5 (first communication network). The first to n-th nodes 3 and the backup node 10 are coupled with each other also via the back-end network 6 (second communication network).

A storage network 7 shown in FIG. 1A is, for example, a LAN, a SAN (Storage Area Network), or the like. The first to n-th nodes 3 and the first to n-th storages 4 subordinate to the respective nodes 3 are coupled via the storage network 7. The backup node 10 and the backup storage 11 are coupled with each other via the storage network 7. The backup apparatus 12 is coupled with the backup storage 11 via the storage network 7. Note that the front-end network 5 and the back-end network 6 are shown by solid lines and the storage network 7 is shown by a broken line in FIG. 1.

FIG. 1B shows an example of a hardware configuration of a computer 50 (information processing apparatus) which can be used as the client 2, the first to n-th nodes 3, and the backup node 10. As shown in FIG. 1B, the computer 50 includes a CPU 51, a memory 52 (RAM (Random Access Memory), a ROM (Read Only Memory), or the like), a storage device 53 (a hard disk, a semiconductor storage device (SSD: Solid State Drive, or the like), an input device 54 (keyboard, mouse, or the like) which receives operation input from a user, an output device 55 (liquid crystal monitor, printing device, or the like), and a communication interface 56 (NIC (Network Interface Card), HBA (Host Bus Adapter), or the like) which implements communication with other apparatuses.

FIG. 1C shows an example of a hardware configuration of the storage 4 and the backup storage 11. As shown in FIG. 1C, storage 60 includes a disk controller 61, a cache memory 62, a communication interface 63, and disk devices 64 (built in a housing or coupled externally). The disk controller 61 includes a CPU and a memory. The disk controller 61 performs various processes for implementing the function of the storage 60. The disk device 64 includes one or more hard disks 641 (physical disks). The cache memory 62 stores data to be written in the disk device 64 or data read from the disk device 64, for example.

The communication interface 63 is an NIC or HBA, for example. The backup storage 11 is coupled with the backup apparatus 12 via the storage network 7. Therefore, data transfer can be performed in block units between the backup storage 11 and the backup apparatus 12. The backup apparatus 12 is, for example, a DAT tape apparatus, an optical disk apparatus, a magneto-optical disk apparatus, a semiconductor storage apparatus, or the like.

The disk device 64 controls the hard disk 641 with a RAID (Redundant Arrays of Inexpensive (or Independent) Disks) system (RAID 0 to RAID 6). The disk device 64 provides logical volumes based on storage regions of RAID groups.

Note that specific examples of the storage 60 having the configuration described above include a channel adapter for communicating with a host, a disk adapter which performs input/output of data for a hard disk, a cache memory used for exchanging data between the channel adapter and the disk adapter or the like, and a disk array apparatus including a communication mechanism such as a switch which couples respective apparatuses with each other.

### =File Managing Method=

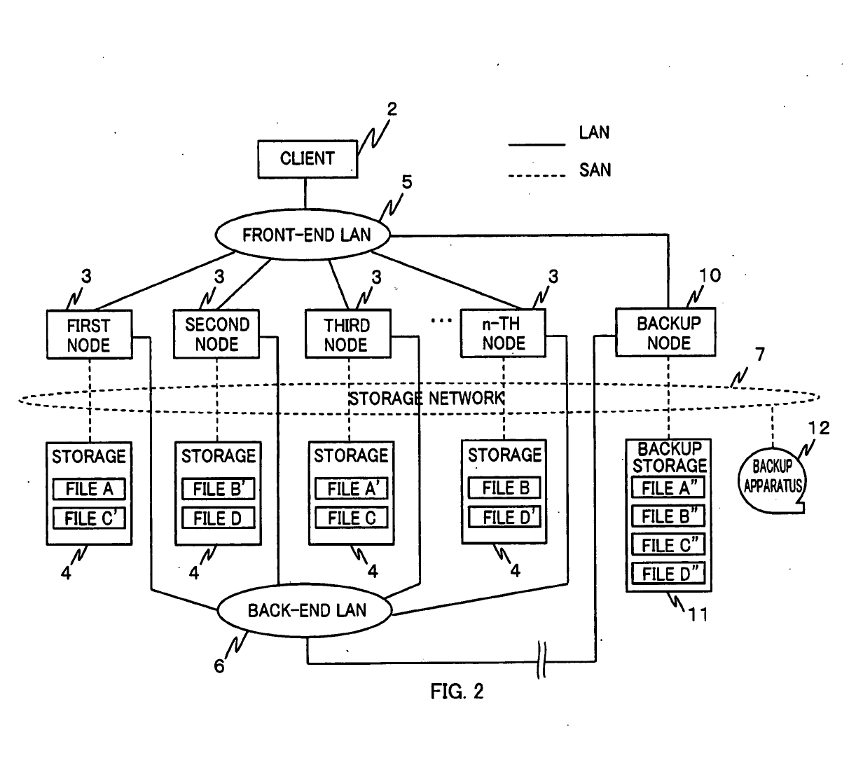

FIG. 2 is a view illustrating a method of storing files in the first to n-th storages 4. The first to n-th storages 4 store original files (archive files) and replica files copied from the original files. In FIG. 2, file A, file B, file C, and file D are original files. And file A′, file B′, file C′, and file D′ are respectively replica files of the original files A, B, C, and D.

Note that the original file and the replica file are stored in different storages 4 in order to prevent a situation where both the original file and the replica file are damaged due to a failure or the like. The replica file is created or updated by the first to n-th nodes 3 in the case where the original file is stored in the storage 4 or when the original file is updated, for example.

As shown in FIG. 2, the backup storage 11 stores respective backup files (file A″, file B″, file C″, and file D″) of the original files. Details of the backup files will be described later.

### =Description of Functions=

Next, the main functions of the information processing system 1 will be described. The client 2 transmits file creation requests (new file creation storage requests) to the first to n-th nodes 3 via the front-end network 5. The first to n-th nodes 3 create original files upon receiving the file creation requests, and store the created original files in one of the first to n-th storages 4. The first to n-th nodes 3 create replica files of the created original files, and store the created replica files in storages 4 of nodes 3 different from the nodes 3 storing the original files. Note that the replica file is basically created by the node 3 in which the replica file is to be stored. After the original files and the replica files are stored, the node 3 which has received the file creation request from the client 2 transmits a file storage completion notification to the client 2 via the front-end network 5.

The client 2 transmits file access requests (file update requests, file read requests, or the like) to the first to n-th nodes 3 via the front-end network 5. The first to n-th nodes 3 access the files stored in one of the first to n-th storages 4 upon receiving the file access requests, and return data requested by the file access requests to the client 2. Note that, in the case where original file is updated in accordance with the file access requests, the first to n-th nodes 3 also update the replica files of the original files.

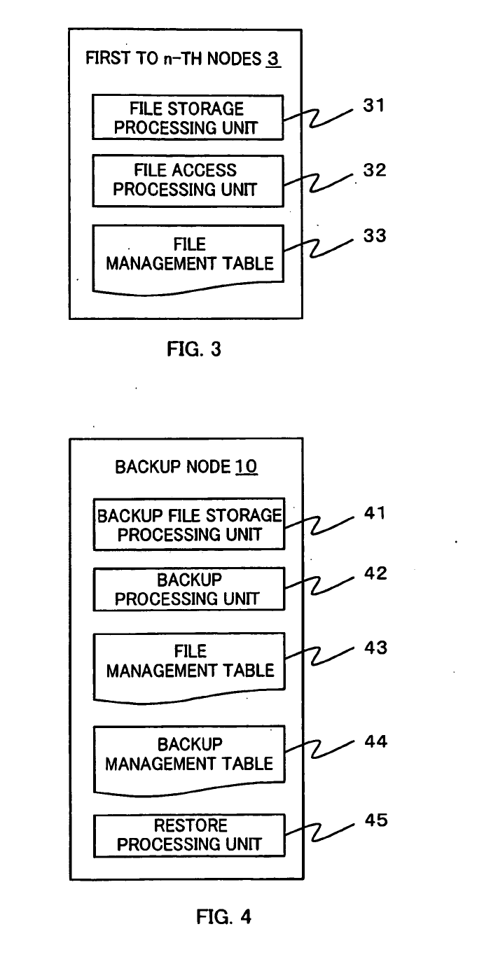

FIG. 3 shows functions of the first to n-th nodes 3 and a table held by each node 3. Note that the functions shown in FIG. 3 are achieved by the CPUs 51 of the first to n-th nodes 3 executing programs stored in the memories 52.

As shown in FIG. 3, the first to n-th nodes 3 include respective functions of a file storage processing unit 31 and a file access processing unit 32. The file storage processing unit 31 stores a new original file in the storage 4 in accordance with the file creation request transmitted from the client 2. The file storage processing unit 31 creates a replica of the original file newly stored, and stores the created replica file in a storage 4 different from the storage 4 storing the original file.

The file access processing unit 32 accesses the original file (reads data or updates file) stored in the storage 4 in accordance with the file access request (data read request or file update request, or the like) sent from the client 2, and returns the result (read data, update completion notification, or the like) to the client 2.

The file management table 33 manages a storage location, last update date and time, and the like of the file. The details of the file management table 33 will be described later.

FIG. 4 shows functions of the backup node 10 and tables held by the backup node 10. Note that the functions shown in FIG. 4 are achieved by the CPU 51 of the backup node 10 executing programs stored in the memory 52. As shown in FIG. 4, the backup node 10 includes a backup file storage processing unit 41, a backup processing unit 42, and a restore processing unit 45.

The backup file storage processing unit 41 creates a backup file of the original file in accordance with an instruction from the client 2, a management apparatus coupled to the backup node 10, or the like, and stores the created backup file in the backup storage 11.

The backup processing unit 42 copies the backup file stored in the backup storage 11 in a recordable medium of the backup apparatus 12.

A file management table 43 manages a storage location, last update date and time, and the like of the file. The content of the file management table 43 is synchronized in real time with the content of the file management tables 33 held by the first to n-th nodes 3 through mutual communications between the first to n-th nodes 3 and the backup node 10.

The restore processing unit 45 performs a restore process using the file management table 43 and the backup file stored in the backup storage 11 in the case where the files of the first to n-th storages 4 are deleted, damaged, or the like due to failures of the first to n-th nodes 3, for example.

Note that the first to n-th nodes 3 and the backup node 10 have functions as NAS apparatuses (NAS: Network Attached Storage), and have file systems of UNIX® or Windows®, for example. The first to n-th nodes 3 and the backup node 10 have a file sharing system 211 of a NFS (Network File System) or a CIFS (Common Internet File System), for example.

### =Description of Tables=

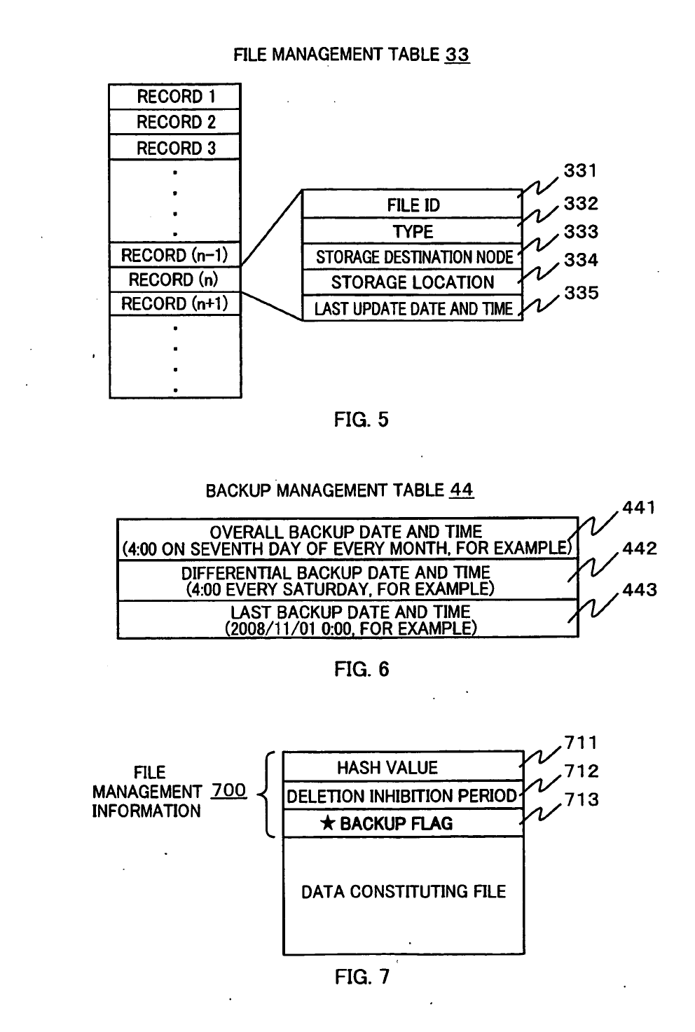

FIG. 5 shows the configuration of the file management table 33. The file management table 33 is a table managed by a DBMS (Database Management System), for example. The file management tables 33 and 43 are held in the first to n-th nodes 3 and the backup node 10, respectively. As described above, the contents of the file management tables 33 held in the respective nodes 3 are synchronized with each other in real time by performing information exchange between the first to n-th nodes 3 and the backup node 10.

As shown in FIG. 5, the file management table 33 has records corresponding to respective files (original file, replica file, and backup file) stored in the storage 4 and the backup storage 11.

Each record has respective items of a file ID 331, a type 332, a storage destination node 333, a storage location 334, and a last update date and time 335. The file ID 331 stores an identifier (for example, file name) of a file. The type 332 stores information (file type) showing whether the file is an original file, a replica file, or a backup file. In this embodiment, a “0” in the case of an original file, “1 to N (N is a number assigned in accordance with the number of copies)” in the case of a replica file, or “−1” in the case of a backup file is stored. In this manner, the file management table 33 manages information of all files stored in the first to n-th storages 4 and the backup storage 11.

The storage destination node 333 stores information (storage destination information) showing the node 3 managing the file (e.g., the file is stored in the n-th storage 4 in the case of the n-th node 3). In this embodiment, a node number (1 to n) in the case where the file is stored in one of the first to n-th storages 4 subordinate to the first to n-th nodes 3 or “−1” is stored in the case where the file is stored in the backup storage 11 subordinate to the backup node 10.

The storage location 334 stores information (for example, file path such as “C:¥data¥FB773FMI4J37 DBB”) showing the storage location in the node 3 where the file is managed.

The last update date and time 335 stores information (for example, time stamp) showing the date and time of the most recent update of the file.

FIG. 6 shows an example of a backup management table 44 held by the backup node 10. The content of the backup management table 44 can be set from a user interface (such as the input device 54 and output device 55) of the client 2 or the backup node 10 (or a management apparatus coupled therewith). The backup management table 44 is appropriately created or updated by an automatic schedule creation function operated by the backup node 10.

As shown in FIG. 6, the backup management table 44 has respective items of an overall backup date and time 491, a differential backup date and time 442, and a last backup date and time 443. The overall backup date and time 441 stores the date and time scheduled (scheduled overall backup date and time) to create backup files for all original files stored in the respective first to n-th storages 4. The backup of all data constituting such original files is performed for the purpose of ensuring reliability and security of the files, for example.

The differential backup date and time 442 stores the date and time scheduled (scheduled differential backup date and time) to create backup files for a file updated (files of which the last update date and time is the last backup date and time 443 or later) at the last backup date and time 443 or later, on of the original files stored in the respective first to n-th storages 4.

The last backup date and time 443 stores the date and time at which the most recent backup (overall backup or differential backup) has been performed (last backup date and time).

FIG. 7 shows a configuration of file management information 700 which is information managed in correspondence with the respective files stored in the first to n-th storages 4 and the backup storage 11. The file management information 700 is stored together with (to accompany) the file in the storage 4 or the backup storage 11 storing the corresponding file, for example.

The file management information 700 is appropriately created or updated by the file storage processing units 31 or the file access processing units 32 of the first to n-th nodes 3. The file management information 700 is also appropriately created or updated by the backup file storage processing unit 41 or the backup processing unit 42 of the backup node 10.

As shown in FIG. 7, the file management information 700 has respective items of a hash value 711, a data deletion inhibition period 712, and a backup flag 713.

The hash value 711 stores a hash value obtained by a predetermined calculating formula from data constituting the corresponding file. The hash values are calculated by the file storage processing units 31 or the file access processing units 32 of the first to n-th nodes 3, for example. The hash value is used when judging agreement or disagreement of the original file and the replica file, for example.

The data deletion inhibition period 712 stores a period (deletion inhibition period, e.g., “2010/01/010:00”) during which deletion of the corresponding file is inhibited. The deletion inhibition period can be set from the user interface (such as the input device 54 and output device 55) of the client 2 or the backup node 10 (or the management apparatus coupled therewith), for example.

The backup flag 713 stores a flag (backup flag) showing whether or not creating the backup file is necessary. In this embodiment, “1” in the case where creating the backup file is necessary or “0” in the case where creating the backup file is unnecessary is stored. The backup flags 713 are appropriately set (registered, updated, or deleted) by instructions from the client 2 or by the file storage processing units 31 or the file access processing units 32 of the first to n-th nodes 3 or the backup file storage processing units 91 or the backup processing units 42 of the backup node 10.

### =Description of Processes=

Next, the processes performed in the information processing system 1 will be described.

### <File Storage Process>

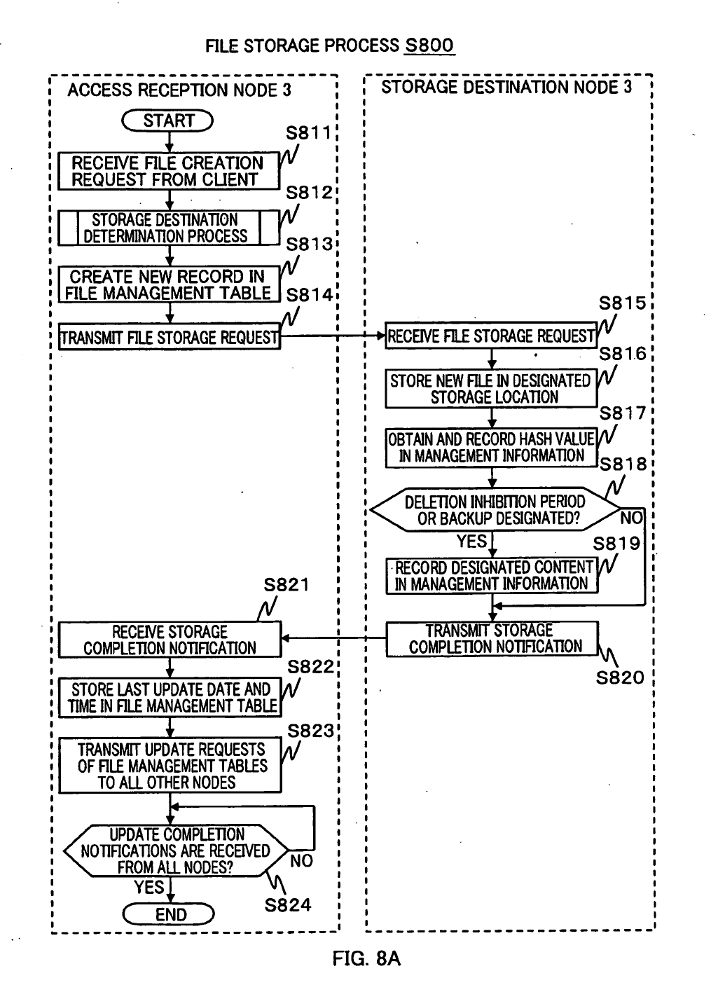

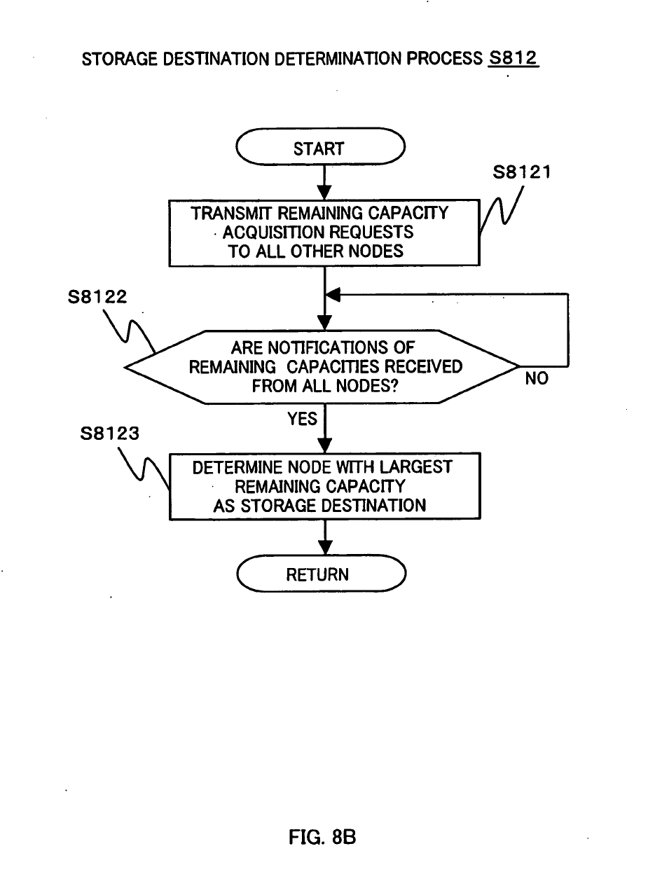

FIG. 8A is a flowchart illustrating a process (file storage process S800) performed by the file storage processing units 31 of the first to n-th nodes 3. Note that, in the description below, a “file creation request reception node 3” refers to the node 3 which has received the file creation request from the client 2, and a “storage destination node 3” refers to the node 3 storing a new file created in accordance with the file creation request. Hereinafter, description will be given along with the flowchart.

Upon receiving the file creation request from the client 2 (S811), the file storage processing unit 31 of the file creation request reception node 3 executes a storage destination determination process S812. In the storage destination determination process S812, the storage destination of the file (storage destination node 3 and the storage location (file path) in the storage destination node 3) is determined based on the remaining capacities or the like of the storages 4 subordinate to the first to n-th nodes 3.

FIG. 8B shows the details of the storage destination determination process S812. As shown in FIG. 8B, the file storage processing unit 31 first transmits remaining capacity notification requests of the storages 4 to all nodes 3 of the first to n-th nodes 3 excluding itself (S8121). Upon receiving the notifications of the remaining capacities from all of the nodes 3 to which the remaining capacity notification requests have been transmitted (S8122: YES), the file storage processing unit 31 compares the received remaining capacities and determines the node 3 having the largest remaining capacity as the storage destination (S8123). Then, the process returns to S813 of FIG. 8A.

Note that, although the storage destination is determined based on the remaining capacity of each node 3 in the process shown in FIG. 8A, the storage destination may be determined based on information other than the remaining capacity (for example, processing performance of each node 3).

In the subsequent S813, the file storage processing unit 31 creates a new record in the file management table 33. In S819, the file storage processing unit 31 transmits the file storage request together with the determined storage destination (storage destination node 3 and the storage location (file path) in the storage destination node 3) to the storage destination node 3 determined in S812.

Upon receiving the file storage request (S815), the file storage processing unit 31 of the storage destination node 3 creates a new file (while also ensuring a storage area of management information), and stores the created new file in the received storage location (S816).

Note that the replica file is stored in the storage 4 at this timing, for example. In this case, for example, the file storage processing unit 31 of the file creation request reception node 3 performs the storage destination determination process S812 for the replica file to determine the storage destination of the replica file, and instructs creation or storage of the replica file in the determined storage destination node 3. The storage destination node 3 creates a replica file of the new file and stores the replica file in the storage 4 of itself. Note that the load is distributed throughout the nodes 3 by causing the storage destination to the create replica file in this manner.

Next, the file storage processing unit 31 of the storage destination node 3 calculates the hash value of the new file, and stores the calculated hash value in the management information of the new file (S817).

Subsequently, the file storage processing unit 31 of the storage destination node 3 judges whether or not the file creation request from the client 2 includes designation of the deletion inhibition period or backup (S818). Note that this designation is transmitted to the storage destination node 3 together with the file storage request in S814.

In the case where there is at least one of the designations (S818: YES), the file storage processing unit 31 stores the designation content in the management information of the new file and the replica file (S819). If neither is designated (S818: NO), the process proceeds to S820.

In the subsequent S820, the file storage processing unit 31 of the storage destination node 3 transmits the file storage completion notification to the file creation request reception node 3.

In S821, the file storage processing unit 31 of the file creation request reception node 3 receives the storage completion notification.

In S822, the file storage processing unit 31 of the file creation request reception node 3 updates the last update date and time 335 of the file management table 33 of the new file.

In S823, the file storage processing unit 31 of the file creation request reception node 3 transmits update requests of the file management tables 33 to the first to n-th nodes 3 other than itself and the backup node 10.

Subsequently, the file storage processing unit 31 waits for the update completion notifications of the file management tables 33 (S824). When the update completion notifications are received from all of the nodes 3 to which the update requests have been transmitted (S829: YES), the process is terminated.

In this manner, the original file and the replica file are stored in the corresponding storage 4 in accordance with the file creation request transmitted from the client 2 by the file storage process S800. If there is a hash value or a deletion inhibition period or a backup designation, they are stored in the corresponding storage 4 as management information together with the original file and the replica file.

Note that, when the content of the file management table 33 of the file creation request reception node 3 is updated by the processes described above, the file management tables 33 held by all of the other first to n-th nodes 3 and the backup node 10 are also updated (synchronized) in real time to have the same contents.

### <File Access Process>

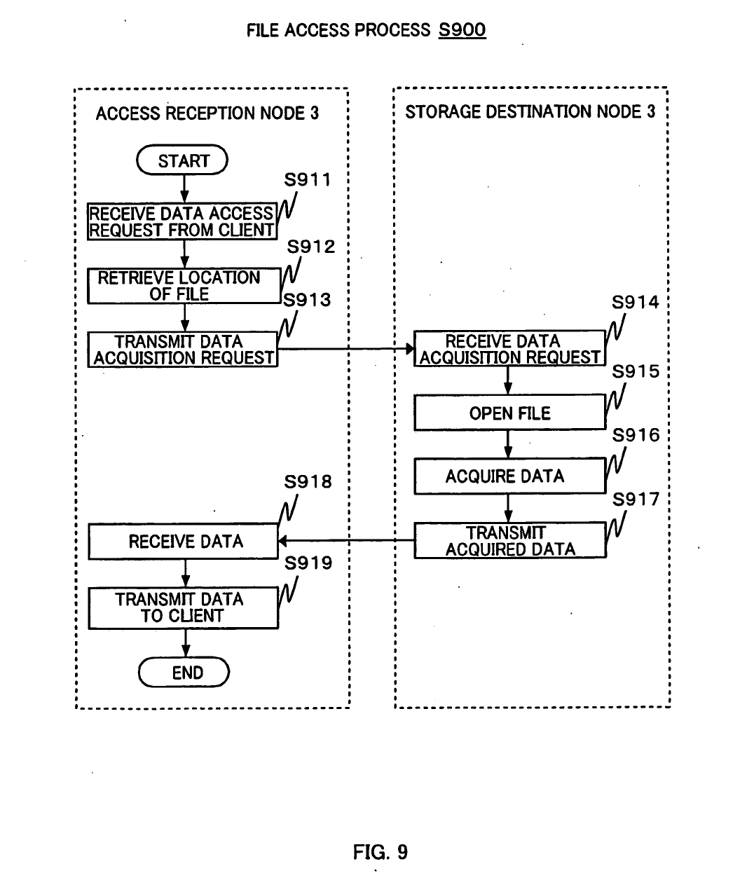

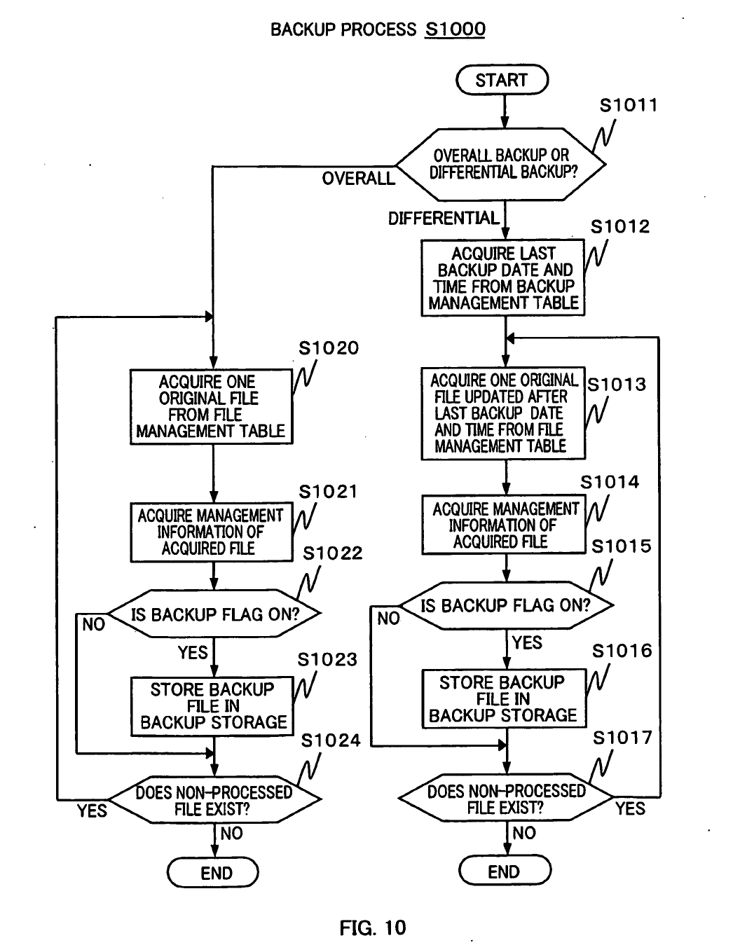

FIG. 9 is a flowchart illustrating a process (file access process S900) performed by the file access processing units 32 of the first to n-th nodes 3. Note that, in the description below, an “access reception node 3” is the node 3 which has received the file access request from the client 2, and a “storage destination node 3” is the node 3 storing the subject original file to be accessed by the file access request.

As shown in FIG. 9, upon receiving the file access request from the client 2 (S911), the file access processing unit 32 of the access reception node 3 refers to the file management table 33 of itself to retrieve the original file of the file access request, and acquires the storage destination node 3 of the original file (S912).

Next, the file access processing unit 32 transmits data acquisition request to the acquired storage destination node 3 (S913).

Upon receiving the data acquisition request (S914), the file access processing unit 32 of the storage destination node 3 opens the corresponding file (S915), and accesses the opened file to acquire data requested in the data acquisition request (S916).

Next, the file access processing unit 32 of the storage destination node 3 transmits the acquired data to the access reception node 3 (S917).

Upon receiving the data sent from the storage destination node 3 (S918), the file access processing unit 32 of the access reception node 3 transmits the received data to the client 2 which has transmitted the data acquisition request (S919).

As described above, upon receiving the file access request from the client 2, the access reception node 3 acquires the location of the object original file for the file access request based on the file management table 33 held by itself, and acquires the data requested in the file access request from the node 3 storing the original file to respond to the client 2.

### <Backup Process>

FIG. 10 is a flowchart illustrating a process (backup process S1000) performed by the backup file storage processing unit 41 of the backup node 10. This process is performed in the case where the backup file storage processing unit 41 receives a backup acquisition request from the client 2, for example. It is also performed once the backup file storage processing unit 91 detects that the backup date and time stored in the overall backup date and time 941 of the backup management table 44 or the differential backup date and time stored in the differential backup date and time 442 has arrived.

In S1011, the backup file storage processing unit 41 judges whether it is an overall backup or a differential backup. If it is an overall backup (S1011: OVERALL), the process proceeds to S1020. If it is a differential backup (S1011: DIFFERENTIAL), the process proceeds to S1012.

In S1012, the backup file storage processing unit 41 acquires the date and time (last backup performance date and time) stored in the last backup performance date and time 443 from the backup management table 44.

In S1013, the backup file storage processing unit 41 refers to the content of the last update date and time 335 of each record of the file management table 33, and acquires one original file (file ID) updated after the date and time of the last backup from the file management table 33.

In S1014, the backup file storage processing unit 41 accesses the storage 4 storing the original file acquired via the back-end network 6, and acquires the file management information 700 of the acquired original file.

In S1015, the backup file storage processing unit 41 judges whether the backup flag 713 of the acquired original file is on or not. If it is on (S1015: YES), the backup file storage processing unit 41 acquires the original file via the back-end network 6 from the storage 4 storing the original file to create a backup file (S1016), and stores the created backup file in the backup storage 11. If it is not on (S1015: NO), the process proceeds to S1017.

In S1017, the backup file storage processing unit 41 judges whether or not there is another original file not acquired in S1013. If there is another non-acquired original file (S1017: YES), the process returns to S1013. If there is no non-acquired original file (S1017: NO), the process is terminated.

In S1020, the backup file storage processing unit 41 acquires one original file (file ID) from the file management table 33.

In S1021, the backup file storage processing unit 91 accesses the storage 4 storing the original file acquired via the back-end network 6, and acquires the file management information 700 of the acquired original file.

In S1022, the backup file storage processing unit 41 judges whether the backup flag 713 of the acquired original file is on or not. If it is on (S1022: YES), the backup file storage processing unit 41 acquires the original file via the back-end network 6 from the storage 4 storing the original file to create a backup file (S1023), and stores the created backup file in the backup storage 11. If it is not on (S1022: NO), the process proceeds to S1024.

In S1024, the backup file storage processing unit 41 judges whether or not there is another original file not acquired in S1020. If there is another non-acquired original file (S1024: YES), the process returns to S1020. If there is no non-acquired original file (S1024: NO), the process is terminated.

As described above, according to the backup process S1000, the backup of the original file of which the backup flag is on is automatically created by the backup file storage processing unit 41 and stored in the backup storage 11, when the date and time (overall backup date and time or differential backup date and time) designated by the backup management table 44 has arrived.

In this manner, in the information processing system 1, the backup file is automatically created by the backup node 10 and, and the backup file is stored in the backup storage 11. Therefore, in acquiring the backup file, the load (for example, retrieval load of the file management table 33) on the first to n-th nodes 3 can be made small (such that only communication loads occur for the first to n-th nodes 3 in acquiring the original files.

Since the acquisition of the original file necessary for creating the backup is performed via the back-end network 6, there is no load on the front-end network 5, and the client 2 is hardly influenced.

Since the backup node 10 uses the back-end network 6, the backup process S1000 can be executed independently of (asynchronous with) the process (process regarding the file storage request or file access request from the client 2) on the front-end network 5 side. Therefore, for example, the backup process S1000 can be executed while avoiding a time zone in which the process load on the front-end network 5 side is high, and the backup file can be created efficiently while avoiding influence on the client 2 side.

By performing the backup process S1000 regularly and the like or frequently in a short cycle time, the amount of files to be processed at the same time is reduced to distribute load in terms of time.

As described above, the backup file stored in the backup storage 11 can be backed up (copied) in a recording medium (tape, magneto-optical disk, or the like) of the backup apparatus 12 via the storage network 7. In this case, since the data transfer from the backup storage 11 to the backup apparatus 12 is performed by a block transfer via the storage network 7, the backup for the recording medium can be performed at high speed.

### <Restore Process>

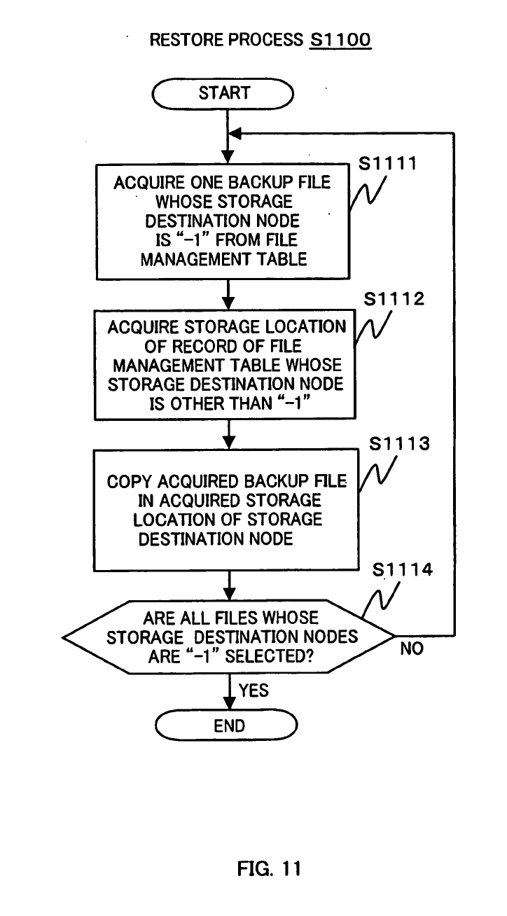

FIG. 11 is a flowchart illustrating a process (restore process S1100) performed by the restore processing unit 45. This process is performed when restoring files (original files and replica files) of the first to n-th storages 4 in the case where the files of the first to n-th storages 4 have been deleted, damaged, or the like due to a failure in the first to n-th nodes 3 and then hardware of the first to n-th storages 4 has been restored.

In the process shown in FIG. 11, the restore processing unit 45 uses the file management table 43 held by itself and the backup files (respective backup files of the original files and the replica files) stored in the backup storage 11 to restore the files in the first to n-th storages 4. Hereinafter, the restore process S1100 will be described in detail along with the flowchart.

In restoring the first to n-th storages 4, the restore processing unit 45 first acquires one file (file ID) for which “−1” is stored in the storage destination node 333, i.e., backup file of the original file or replica file stored in the backup storage 11, from the file management table 43 held by itself (S1111).

Next, the restore processing unit 45 acquires files (file IDs) other than those for which “−1” is stored in the storage destination node 333 of the acquired backup file, i.e., all original files or replica files stored in any of the first to n-th nodes 3, and acquires the storage destination nodes and storage locations of all the acquired files from the file management table 43 (S1112).

Next, the restore processing unit 45 stores the backup files acquired from the backup storage 11 in S1111 in the acquired storage destination nodes and storage locations (such that the backup file is stored in the location where the original file or the replica file has been originally stored) (S1113). Note that the data transfer at this time is performed by block transfer via the storage network 7.

In S1114, the restore processing unit 45 judges whether or not all the files of which the storage destination nodes are “−1” have been selected. If there is an unselected file (original file or replica file) (S1114: NO), the process returns to S1111. If all files have been selected (S1114: YES), the process is terminated.

According to the restore process S1110 described above, the files (original files and replica files) stored in the first to n-th storages 4 can be easily and reliably be restored based on the file management table 43 held by the backup node 10 and the backup file stored in the backup storage 11, in the case where the files of the first to n-th storages 4 are deleted, damaged, or the like due to a failure in the first to n-th nodes 3 and then the hardware of the first to n-th storage 4 is restored.

In this manner, the backup node 10 and the backup storage 11 are provided in the information processing system 1; the backup node 10 holds the file management table 43 synchronized with the file management tables 33 held by the first to n-th nodes 3, while the backup storage 11 holds the backup files of the files (original files and replica files) held by the first to n-th nodes 3, whereby the entire information processing system 1 can be restored easily and promptly to a state before a failure, when the failure has occurred in the first to n-th storages 4. The replication of data from the backup storage 11 to the first to n-th storages 4 is performed by block transfer via the storage network 7, thereby achieving faster restoration.

An embodiment of the present invention has been described above for an easier understanding of the present invention, but is not intended to limit the present invention. The present invention may be changed or modified without departing from the gist thereof and also includes equivalents thereof.

For example, although a case has been described where data is stored in the storage 4 in units of files, the present invention may also be applied to a case where data is stored in the storage 4 in units other than files.

Ways for acquiring the original file, replica file, and backup file 5, are not limited. For example, they may be acquired in a combination of “the original file and the backup file” or “the original file, first replica file, second replica file, and the backup file.”

1. An information processing system comprising:
a plurality of nodes coupled with a client,
a plurality of storages coupled subordinately to the respective nodes,
a backup node coupled with each of the nodes, and
a backup storage coupled subordinately to the backup node,
wherein each of the nodes synchronizes and holds location information as information showing a location of a file stored in each of the storages;
wherein each of the nodes functions as a virtual file system that provides the client with storage regions of the storages as a single namespace; and
wherein the backup node stores, as a replica of the file, a backup file in the backup storage by synchronizing and holding the location information held by each of the nodes, and acquiring the file by accessing the location identified by the location information synchronized and held by the backup node itself.

2. The information processing system according to claim 1,
wherein the information processing system holds a backup flag showing whether or not a backup is necessary for each of the files in addition to the files stored in each of the storages, and
wherein the backup node
acquires the backup flag of the files by accessing a location identified by the location information, and
stores in the backup storage only the backup file of the file to which the backup flag is set as backup necessary.

3. The information processing system according to claim 1,
wherein an original file is stored in one of the storages;
wherein a replica file as a replica of the original file is stored in a storage different from the storage storing the original file; and
wherein the backup node stores in the backup storage a backup file of each of the original file and the replica file.

4. The information processing system according to claim 1,
wherein a backup apparatus is coupled to the backup storage via a storage network, and
wherein the backup storage transfers the backup file stored in the backup storage itself to the backup apparatus via the storage network.

5. The information processing system according to claim 1,
wherein the backup node
identifies a location of a file stored in each of the nodes on the basis of the synchronized location information held by the backup node itself, and
transfers the backup file stored in the backup storage to the identified location.

6. A method for acquiring a backup in an information processing system including
a plurality of nodes coupled with a client,
a plurality of storages coupled subordinately to the respective nodes,
a backup node coupled with each of the nodes, and
a backup storage coupled subordinately to the backup node,
wherein each of the nodes synchronizes and holds location information as information showing a location of a file stored in each of the storages,
each of the nodes function as a virtual file system which provides the client with storage regions of the storages as a single namespace, the method comprising:
a step performed by the backup node of storing, as a replica of the file, a backup file in the backup storage by synchronizing and holding the location information held by each of the nodes, and acquiring the file by accessing the location identified by the location information synchronized and held by the backup node itself.

7. The method of acquiring a backup in the information processing system according to claim 6,
wherein a backup flag showing whether or not a backup is necessary for each of the files is attached to the file stored in each of the storages; and
wherein the backup node
acquires the backup flag of the file by accessing a location identified by the location information, and
stores in the backup storage only the backup file of the file to which the backup flag is set as backup necessary.

8. The method of acquiring a backup in the information processing system according to claim 6,
wherein an original file is stored in one of the storages;
wherein a replica file as a replica of the original file is stored in a storage different from the storage storing the original file, and
wherein the backup node stores in the backup storage a backup file of each of the original file and the replica file.

9. The method of acquiring a backup in the information processing system according to claim 6,
wherein a backup apparatus is coupled to the backup storage via a storage network, and
wherein the backup storage transfers the backup file stored in the backup storage itself to the backup apparatus via the storage network.

10. The method of acquiring a backup in the information processing system according to claim 6,
wherein the backup node
identifies a location of a file stored in each of the nodes on the basis of the location information synchronized and held by the backup node itself, and
transfers the backup file stored in the backup storage to the identified location.
